(19) United States
(12) Patent Application Publication
(10) Pub. No.: US 2016/0151735 A1
(43) Pub. Date: Jun. 2, 2016

(54) SYSTEM FOR SEPARATING OUT VOLATILE DEGRADATION PRODUCTS, AND METHOD FOR OPERATING THE SYSTEM

(71) Applicant: SIEMENS AKTIENGESELLSCHAFT, Munich (DE)

(72) Inventors: Björn Fischer, Dusseldorf (DE); Ralph Joh, Seligenstadt (DE); Markus Kinzl, Dietzenbach (DE); Diego Andres Kuettel, Kassel (DE); Rüdiger Schneider, Eppstein (DE)

(73) Assignee: Siemens Aktiengesellschaft, Munich (DE)

(21) Appl. No.: 14/905,560

(22) PCT Filed: Jul. 9, 2014
(86) PCT No.: PCT/EP2014/064732

§ 371 Date: Jan. 15, 2016

(30) Foreign Application Priority Data
Jul. 25, 2013 (DE) 10 2013 214 546.2

(51) Int. Cl. B01D 53/14

(52) U.S. Cl. CPC B01D 53/1475; B01D 53/1487; B01D 53/1406; B01D 2252/60

(57) ABSTRACT

A system for separating volatile degradation products out of a flue gas stream from a load-dependent combustion apparatus includes a CO₂ separation apparatus, wherein the CO₂ separation apparatus has fluidic coupling to the combustion apparatus, wherein the CO₂ separation apparatus comprises at least one quench apparatus through which at least part of the flue gas stream flows and which at least partly forms an acidified quench condensate, and an absorber through which at least part of the flue gas stream flows, wherein at least part of the flue gas flows into a cleaning apparatus connected downstream of the absorber, wherein the cleaning apparatus is supplied with a cleaning medium for cleaning the flue gas, wherein the cleaning medium at least partly comprises the acidified quench condensate. A method for operating such a system includes separating volatile degradation products out of a flue gas stream.

### CROSS REFERENCE TO RELATED APPLICATIONS

This application is the US National Stage of International Application No. PCT/EP2014/064732 filed Jul. 9, 2014, and claims the benefit thereof. The International Application claims the benefit of German Application No. DE 102013214546.2 filed Jul. 25, 2013. All of the applications are incorporated by reference herein in their entirety.

### FIELD OF INVENTION

The invention relates to a plant for capturing volatile degradation products. The invention further relates to a method of operating such a plant.

### BACKGROUND OF INVENTION

In fossil fuel power stations for generating electricity the combustion of a fossil fuel forms a carbon dioxide-containing flue gas. To prevent or reduce carbon dioxide emissions, carbon dioxide needs to be removed from the flue gases. In general, various methods for removing carbon dioxide from a gas mixture are known. The particular task of removing carbon dioxide from a flue gas downstream of a combustion process is commonly performed using the absorption-desorption method. On a large industrial scale this comprises scrubbing carbon dioxide out of the flue gas with an absorption medium (CO₂ capture process). Such a CO₂ capture process essentially comprises an absorber in which CO₂ is scrubbed out of the flue gas with an absorption solution and a desorber in which CO₂ is expelled from the absorption solution again.

Commonly used absorption solutions, such as monoethanolamine (MEA), amino acid salt solutions or potash solutions for example, show good selectivity and a high capacity for CO₂.

The trace elements contained in the flue gas, for example SOₓ and NOₓ, but also oxygen in particular, render all absorption solutions liable to degradation. This forms various decomposition products (degradation products) which, in particular when absorption media such as alkanolamines or cyclic amines are employed, are volatile and can exit the absorber with the cleaned flue gas. The resulting emissions are to be reduced to the greatest possible extent.

A first approach to reducing harmful emissions is the use of salts, for example amino acid salts. Aqueous absorption solutions comprising amino acid salts have the advantage that they themselves have no vapor pressure, thus avoiding emissions from the absorber. The decomposition products of absorption solutions comprising amino acid salts resulting from degradation are again largely salts and thus likewise have no appreciable vapor pressure. However, a small portion of the decomposition products does consist of volatile components, for example ammonia.

The decomposition and degradation products are concentrated in the absorption medium circuit over time. Particularly at high temperatures, said products have a propensity to be converted into the gas phase due to the equilibrium. Discharge of these components into the atmosphere is inevitable on account of the large amounts of flue gas and the concentration over time. Attempts to reduce these emissions have hitherto employed a downstream scrubbing at the top of the absorber. This necessitates a larger absorber column and high capital costs and results in a further contaminated wastewater/absorption medium stream.

In the methods disclosed in the patent literature the removal of ammonia from exhaust air is achieved by addition of sulfuric acid or nitric acid. This method, as implemented in U.S. Pat. No. 3,607,022 for example, is also known as “acidic scrubbing”. The ammonia is removed from the exhaust air stream by chemical absorption and converted into the corresponding ammonium salt in the acidic solvent. The use of nitric acid leads to formation of ammonium nitrate and the use of sulfuric acid results in formation of ammonium sulfate.

The acidic scrubbing accordingly entails a high level of cost and complexity in terms of apparatus and logistics since, in addition to the complex scrubber, appropriate amounts of acid need to be purchased and stored.

### SUMMARY OF INVENTION

It is a first object of the invention to specify a plant for capturing volatile degradation products from a flue gas stream of a load-dependent combustion apparatus in simple fashion for the lowest possible energy input. It is a further object of the invention to specify a method of operating such a plant.

The first object is achieved in accordance with the invention by specifying a plant for capturing volatile degradation products from a flue gas stream of a load-dependent combustion apparatus comprising a CO₂ capture apparatus, wherein the CO₂ capture apparatus is fluidly coupled to the combustion apparatus, wherein the CO₂ capture apparatus comprises at least one quenching apparatus which is traversed by the flue gas stream to at least partly form a quench condensate. The CO₂ capture apparatus further comprises an absorber which is at least partly traversed by the flue gas stream, wherein arranged downstream of the absorber in fluid communication therewith is a cleaning apparatus into which the flue gas at least partly flows. This cleaning apparatus is supplied with a cleaning medium for cleaning the flue gas, wherein the cleaning medium at least partly comprises the quench condensate.

The cleaning, in particular an acidic scrub, at the top of the absorber serves especially to reduce levels of basic substances, for example ammonia, short-chain amines or amine-based scrubbing media. The cleaning medium in this acidic scrub is thus especially an acid. However, to achieve levels of these basic substances in the lower ppm-range it is necessary to ensure constant feeding and discharging of this acid, for example sulfuric acid, and of the wastewater into the cleaning circuit. This results not only in chemicals costs for the acid but also in increased wastewater generation.

In accordance with the invention the quench condensate—as described hereinabove—is at least partly employed as cleaning medium. Said condensate is acidified by the quenching apparatus. This not only reduces the levels of wastewater, since there is only one wastewater stream, but also very largely avoids the cost of chemicals, for example of the sulfuric acid, entirely. In the quenching apparatus the hot gas is contacted with a relatively large amount of a cooling medium which may also be composed of the actual condensate and is thus partly or completely condensed. The condensates formed are often highly corrosive. This removes especially inorganic fluorine, chlorine and heavy metal compounds from the flue gases and dissolves them in the cooling medium of the quenching apparatus. The addition of aqueous sodium hydroxide to the water subsequently provides advantageous conditions for a highly effective sulfur dioxide capture. This quench condensate is then at least partly sent to the cleaning apparatus.

It is advantageous when the quench condensate is at least partly formed from a cooling medium that has been contacted with the flue gas inside the quenching apparatus. In the quenching apparatus the flue gas is contacted with a cooling medium to form the quench condensate. This cooling medium which may also be composed of the actual condensate may be contacted with the flue gas thus causing it to partly or completely condense. The recycling of the quench condensate can save water/wastewater. It is advantageous when the quench condensate is formed from at least sulfuric acid and/or sulfate and/or nitric acid and/or salts of sulfate and/or salts of nitrate and/or salts of bicarbonate. The quench condensate is acidified by the acidic gas constituents in the flue gas. It is thus particularly suitable for use as cleaning medium, in particular for an acidic scrub in the cleaning apparatus.

It is advantageous when the quenching apparatus is arranged upstream of the absorber. The flue gas thus arrives at the absorber in a cooled state.

In an advantageous embodiment the flue gas comprises basic substances, in particular ammonia and short-chain amines, which undergo a neutralization reaction with the quench condensate. The cleaning medium exiting the cleaning apparatus is advantageously usable as a fertilizer. It is thus possible to utilize all of the wastewater.

It is advantageous when the cleaning apparatus is connected to a closed cleaning circuit in order that cleaning wastewater formed by the cleaning in the cleaning apparatus may be at least partly recycled into the cleaning apparatus. The cleaning wastewater is thus partly circulated and may therefore also be used repeatedly for cleaning. This produces less cleaning wastewater.

It is advantageous when the quenching apparatus is connected to a quench circuit conduit with which the quench condensate discharged from a quench bottom may be at least partly recycled into the quenching apparatus. This produces less quench condensate.

It is advantageous when the quench circuit conduit comprises a quench withdrawal point where quench condensate is withdrawn, wherein the quench withdrawal point is connected via a conduit to the cleaning apparatus for supply of the quench condensate to the cleaning apparatus. The conduit is advantageously connected to the cleaning apparatus via the closed cleaning circuit.

The second object is achieved in accordance with the invention by specifying a method of operating a plant of the type described hereinabove comprising a quenching apparatus which is at least partly traversed by the flue gas stream to at least partly form an acidified quench condensate. In addition the plant further comprises an absorber which is at least partly traversed by the flue gas stream, wherein arranged downstream of the absorber in fluid communication therewith is a cleaning apparatus into which the flue gas at least partly flows, wherein the cleaning apparatus is supplied with a cleaning medium for cleaning the flue gas. In accordance with the invention the cleaning medium employed at least partly comprises the acidified quench condensate.

The advantages cited for the apparatus apply correspondingly to the process.

### BRIEF DESCRIPTION OF THE DRAWINGS

Further features, properties and advantages of the present invention will be apparent from the following description with reference to the accompanying figure.

FIG. 1 is a schematic diagram of a plant according to the invention for capturing volatile degradation products from a flue gas stream.

### DETAILED DESCRIPTION OF INVENTION

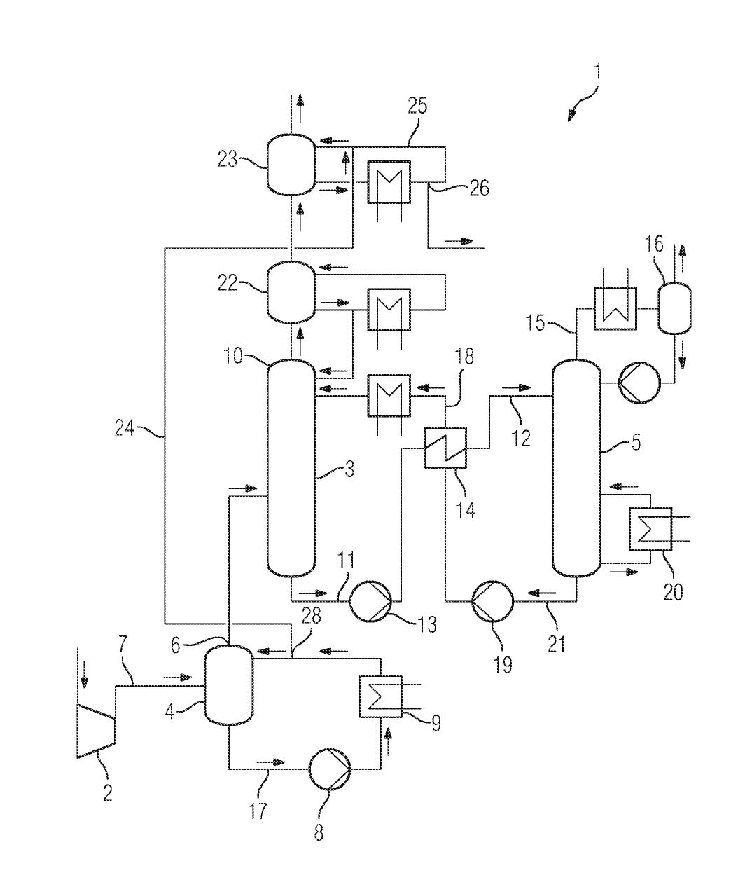

FIG. 1 shows a capture apparatus 1 for capturing carbon dioxide from a flue gas stream. The capture apparatus 1 comprises an absorber 3 and a desorber 5 in fluid communication therewith.

To capture carbon dioxide from the flue gas of a combustion plant the flue gas from a combustion plant 2 is passed into the CO₂ capture apparatus 1. To this end the flue gas is supplied to the quenching apparatus 4 via a flue gas conduit 7.

In the quenching apparatus 4 the hot flue gas is contacted with a relatively large amount of a cooling medium, in particular water, and thus partly or completely condensed. The hot gas is passed through the quenching apparatus 4 in countercurrent or cocurrent. The quench condensate thus formed accumulates at the quench bottom and is often highly corrosive and acidified. The quenching apparatus 4 comprises a flue gas outlet 6 where the cooled and partly cleaned flue gas exits again and is passed to the absorber 3. The quench condensate is conveyed from the quench bottom of the quenching apparatus 4 into a quench circuit conduit 17 comprising a pump 8 and a heat exchanger 9. The quench condensate may be at least partly reintroduced into the quenching apparatus 4. The cooling medium used for cooling the flue gas in the quenching apparatus 4 may thus also be composed of the actual quench condensate. The cooling medium in the quenching apparatus 4 may be an aqueous solution of an amino acid which has been pH-adjusted to a value of from 10 to 13 by appropriate addition of, for instance, potassium hydroxide.

The cleaned flue gas is passed into an absorber 3 for further cleaning. The aqueous amino acid salt solution scrubbing medium present in the absorber 3 is contacted with the flue gas in the absorber 5 and the carbon dioxide present in the flue gas is absorbed in the scrubbing medium.

The gas stream cleaned of carbon dioxide is released from the absorber 3 at the absorber top 10 while the CO₂-laden scrubbing medium is pumped via a discharge conduit 11 of the absorber 3, where said conduit is in fluid communication with a feed conduit 12 of the desorber 5, and by means of a pump 13 to the desorber 5. The carbon dioxide-laden scrubbing medium thus passes through a heat exchanger 14 in which the heat of the regenerated scrubbing medium flowing from the desorber 5 to the absorber 3 is transferred to the laden scrubbing medium sent from the absorber 3 to the desorber 5, thus appropriately preheating the scrubbing medium.

Inside the desorber 5 the carbon dioxide absorbed in the scrubbing medium is thermally desorbed. In order to effect workup and conversion of the carbon dioxide, the desorber 5 is connected to a discharge conduit 15 which is connected to a workup means 16 which is not further described. The desorbed CO₂-rich gas stream may be compressed therein to allow, for example, transport to a storage site.

Also attached to the desorber 5 is a recycling conduit 21 which is in fluid communication with a feed conduit 18 of the absorber 3. The scrubbing medium regenerated in the desorber 5 may thus be recycled by means of a pump 19 into the absorber 3 where it may be utilized for renewed absorption of carbon dioxide from the flue gas.

In order to provide the necessary regeneration heat for separating the carbon dioxide from the scrubbing medium, the desorber 5 is connected to a reboiler heat exchanger 20 in which the laden scrubbing medium is regenerated using steam.

It will be appreciated that such an exemplary plant may also comprise other and/or fewer component parts.

Downstream of the absorber the flue gas may be subjected to further cleaning in an apparatus 22, in particular a water scrub, which is not further described. The flue gas is subsequently sent to a cleaning apparatus 23 for further cleaning. The cleaning is performed using a cleaning medium. Said cleaning is especially performed as an acidic scrub. The acidic scrub captures volatile degradation products from the flue gas stream. In particular it especially reduces the levels of basic substances, for example ammonia, short-chain amines or amine-based scrubbing agents. To achieve levels of these substances in the lower ppm-range it is necessary to ensure constant feeding and discharging of an acid, for example sulfuric acid, as a cleaning medium and of the wastewater into the cleaning apparatus 23/into the circuit of the cleaning apparatus 23. This results not only in chemicals costs for the acid but also in increased wastewater generation.

In accordance with the invention, however, the acidified quench condensate from quenching apparatus 4 is used for feeding the cleaning apparatus 23 and is thus used as an acidic scrub. This not only reduces the levels of wastewater (only one wastewater stream) but also avoids the cost of the chemicals, for example of the sulfuric acid, entirely. The neutralization reaction of sulfates with ammonia moreover forms ammonium sulfate which, like nitrate, is a valuable fertilizer and thus permits utilization of the entire wastewater stream. The quench condensate may be transported to the cleaning apparatus 23 via a conduit 24. The quench circuit conduit 17 comprises a quench withdrawal point 28. The cleaning apparatus 23 too may comprise a closed cleaning circuit 25 so that cleaning wastewater formed by the cleaning in the cleaning apparatus 23 is partly recycled into the cleaning apparatus 23 again. The quench condensate is then advantageously fed into this cleaning circuit 25 via the conduit 24. Thus, the conduit 24 is connected to the quench circuit conduit 17 for quench condensate withdrawal and to the cleaning circuit 25 for feeding into the cleaning apparatus 23. It will be appreciated that the quench condensate which is withdrawn may also be supplied directly to the cleaning apparatus 23. It will be appreciated that it is possible to transport the entire quench condensate to the cleaning apparatus 23 via the conduit 24. However, said condensate may also be partly transported back into the quenching apparatus 4. To this end, the quench circuit conduit 17 may be provided with a control means, for example a valve (not shown).

The cleaning circuit 25 is provided with a withdrawal point 26 where the cleaning wastewater not flowing back to the cleaning apparatus is withdrawn and may be employed as fertilizer as described hereinabove.

The invention therefore results in a marked reduction in chemicals requirements. The amount of wastewater is also reduced since the quench condensate no longer requires separate disposal. The amount of process water is also reduced. The cleaning wastewater may additionally be utilized as fertilizer. The invention also brings about a reduction in emissions.

1. A plant for capturing volatile degradation products from a flue gas stream of a load-dependent combustion apparatus comprising
a CO₂ capture apparatus, wherein the CO₂ capture apparatus is fluidly coupled to the combustion apparatus, wherein the CO₂ capture apparatus comprises at least one quenching apparatus which is at least partly traversed by the flue gas stream to at least partly form an acidified quench condensate and an absorber which is at least partly traversed by the flue gas stream, and
a cleaning apparatus arranged downstream of the absorber and in fluid communication therewith, into which the flue gas at least partly flows,
wherein the cleaning apparatus is supplied with a cleaning medium for cleaning the flue gas,
wherein the cleaning medium at least partly comprises the acidified quench condensate.

2. The plant as claimed in claim 1,
wherein the quench condensate is at least partly formed from a cooling medium that has been contacted with the flue gas inside the quenching apparatus.

3. The plant as claimed in claim 1,
wherein the quench condensate comprises at least sulfuric acid and/or sulfate and/or nitric acid and/or salts of sulfate and/or salts of nitrate and/or salts of bicarbonate.

4. The plant as claimed in claim 1,
wherein the quenching apparatus is arranged upstream of the absorber.

5. The plant as claimed in claim 4,
wherein the cooling medium itself is at least partly formed from the quench condensate.

6. The plant as claimed in claim 1,
wherein the flue gas comprises basic substances, comprising ammonia and short-chain amines, which undergo a neutralization reaction with the quench condensate.

7. The plant as claimed in claim 1,
wherein the cleaning medium exiting the cleaning apparatus is usable as a fertilizer.

8. The plant as claimed in claim 1,
wherein the cleaning apparatus is connected to a closed cleaning circuit in order that cleaning wastewater formed by the cleaning in the cleaning apparatus may be at least partly recycled into the cleaning apparatus.

9. The plant as claimed in claim 1,
wherein the quenching apparatus is connected to a quench circuit conduit with which the quench condensate discharged from a quench bottom may be at least partly recycled into the quenching apparatus.

10. The plant as claimed in claim 9,
wherein the quench circuit conduit comprises a quench withdrawal point where quench condensate is withdrawn, wherein the quench withdrawal point is connected via a conduit to the cleaning apparatus for supply of the quench condensate to the cleaning apparatus.

11. The plant as claimed in claim 8,
wherein the conduit is connected to the cleaning apparatus via the closed cleaning circuit.

12. A method of operating a plant as claimed in claim 1, comprising
partially traversing a quenching apparatus by the flue gas stream to at least partly form an acidified quench condensate and
partially traversing an absorber by the flue gas stream,
supplying a cleaning apparatus with a cleaning medium for cleaning the flue gas, wherein the cleaning apparatus is arranged downstream of the absorber and in fluid communication therewith into which the flue gas at least partly flows,
wherein the cleaning medium employed at least partly comprises the acidified quench condensate.
